(19) United States
(12) Patent Application Publication
(10) Pub. No.: US 2019/0085613 A1
(43) Pub. Date: Mar. 21, 2019

(54) DRIVING DEVICE FOR VEHICULAR OPENING-CLOSING BODY

(71) Applicant: SHIROKI CORPORATION, Fujisawa-shi, Kanagawa (JP)

(72) Inventors: Atsushi MURAMATSU, Fujisawa-shi, Kanagawa (JP); Yoshiki SUGITA, Fujisawa-shi, Kanagawa (JP); Toru IKOMA, Fujisawa-shi, Kanagawa (JP)

(73) Assignee: SHIROKI CORPORATION, Fujisawa-shi, Kanagawa (JP)

(21) Appl. No.: 16/083,287

(22) PCT Filed: Mar. 21, 2017
(86) PCT No.: PCT/JP2017/011223

§ 371 Date: Sep. 7, 2018

(30) Foreign Application Priority Data
May 11, 2016 (JP) 2016-095307

(51) Int. Cl. E05F 15/697; B60J 1/17

(52) U.S. Cl. CPC E05F 15/697; H02K 5/00; B60J 1/17

(57) ABSTRACT

A driving device for a vehicular opening-closing body that ensures stably assembling a drum housing and a motor unit without requiring high positioning accuracy is provided. One of the drum housing and the motor unit includes a plurality of boss portions projecting toward another one of the drum housing and the motor unit, and securing members for securing the drum housing and the motor unit are secured to the plurality of boss portions. The other one of the drum housing and the motor unit includes a plurality of boss receiving portions that receive the plurality of boss portions. At least one of the plurality of boss receiving portions has a reverse tapered surface that has a diameter expanded toward a corresponding boss portion. In a state where the drum housing and the motor unit are supported, a clearance is disposed between the boss portion and the reverse tapered surface.

### TECHNICAL FIELD

The present invention relates to a driving device for a vehicular opening-closing body.

### BACKGROUND ART

Patent Document 1 discloses a driving device for a vehicular opening-closing body that has a resin supporting structure of a drum housing and a motor unit. The drum housing houses a drive drum for driving a vehicular opening-closing body (a window glass). The drum housing includes a boss portion disposed to protrude. The motor unit includes a fitted portion fitted to the boss portion of the drum housing. The fitted portion of the motor unit has a cylindrical portion that abuts on a peripheral edge portion at a base of the boss portion of the drum housing and covers an outer surface of the boss portion, and an inward flange that forms an insertion hole to cover a distal end surface of the boss portion. A tapping screw is used for coupling the drum housing to the motor unit. This tapping screw has a screw portion movably inserted through an insertion hole of the inward flange to be screwed into the boss portion, and a head that sandwiches the inward flange with the distal end surface of the boss portion. A protrusion is disposed to protrude on the distal end surface of the boss portion, and the protrusion is flatly crushed between the inward flange and the distal end surface of the boss portion when the tapping screw is screwed.

### Patent Document 1: JP-A-2014-99956

### DISCLOSURE OF THE INVENTION

### Problems to be Solved by the Invention

However, the driving device for the vehicular opening-closing body disclosed in Patent Document 1 requires extremely high accuracies: on positioning of the boss portion of the drum housing with the fitted portion of the motor unit, and on positioning of a fitting body of the drum housing with the motor unit and the tapping screw, thus possibly making their assemblability of the respective members poor. Screwing the tapping screw in the state where the assembling properties of the respective members are poor possibly causes damages on the drum housing and the motor unit due to a compressive force generated by this screwing, and this possibly causes man-hour loss or a failure in fastening.

The present invention has been made based on the above-described awareness on the problem, and it is an object of the present invention to provide a driving device for a vehicular opening-closing body configured to stably assemble a drum housing and a motor unit without requiring high positioning accuracy.

### Solutions to the Problems

A driving device for a vehicular opening-closing body of the present invention includes a drum housing and a motor unit. The drum housing houses a drive drum. The drive drum drives the vehicular opening-closing body. The motor unit includes an output shaft. The output shaft integrally rotates with the drive drum. One of the drum housing and the motor unit includes a plurality of boss portions projecting toward another one of the drum housing and the motor unit. Securing members for securing the drum housing and the motor unit are secured to the plurality of boss portions. The other one of the drum housing and the motor unit includes a plurality of boss receiving portions that receive the plurality of boss portions. At least one of the plurality of boss receiving portions has a reverse tapered surface that has a diameter expanded toward a corresponding boss portion. In a state where the drum housing and the motor unit are supported, a clearance is disposed between the boss portion and the reverse tapered surface.

The plurality of boss portions and the plurality of boss receiving portions may be disposed so as to surround the output shaft of the motor unit.

The plurality of boss portions may be disposed on the motor unit, the plurality of boss receiving portions may be disposed on the drum housing, and the output shaft of the motor unit may project to the drum housing side with respect to the plurality of boss portions of the motor unit.

The securing member and a distal end portion of the boss portion may be made of metallic material, and at least one of abutting portions of both sides may be squashed.

Abutting portions may be disposed on facing surfaces of a drum housing portion of the drum housing and the motor unit in a direction where the plurality of boss portions and the plurality of boss receiving portions face one another.

### Effects of the Invention

According to the present invention, a driving device for a vehicular opening-closing body configured to stably assemble a drum housing and a motor unit without requiring high positioning accuracy can be provided.

### BRIEF DESCRIPTION OF THE DRAWINGS

FIG. 1 is a front view of a window regulator according to this embodiment.

FIG. 2 is a back view of the window regulator according to the embodiment.

FIG. 3 is a perspective view of a drive drum.

FIG. 4 is a side view of the drive drum viewing in a direction perpendicular to a rotation axis.

FIG. 5 is a perspective view illustrating a configuration of a drum housing.

FIG. 6 is a plan view illustrating a supporting structure of the drum housing and a motor unit.

FIG. 7 is a cross-sectional view taken along a line VII-VII in FIG. 6.

FIG. 8 is a cross-sectional view taken along a line VIII-VIII in FIG. 6.

FIG. 9 is a cross-sectional view illustrating another embodiment of positioning abutting portions of the drum housing and the motor unit corresponding to FIG. 7.

### DESCRIPTION OF PREFERRED EMBODIMENTS

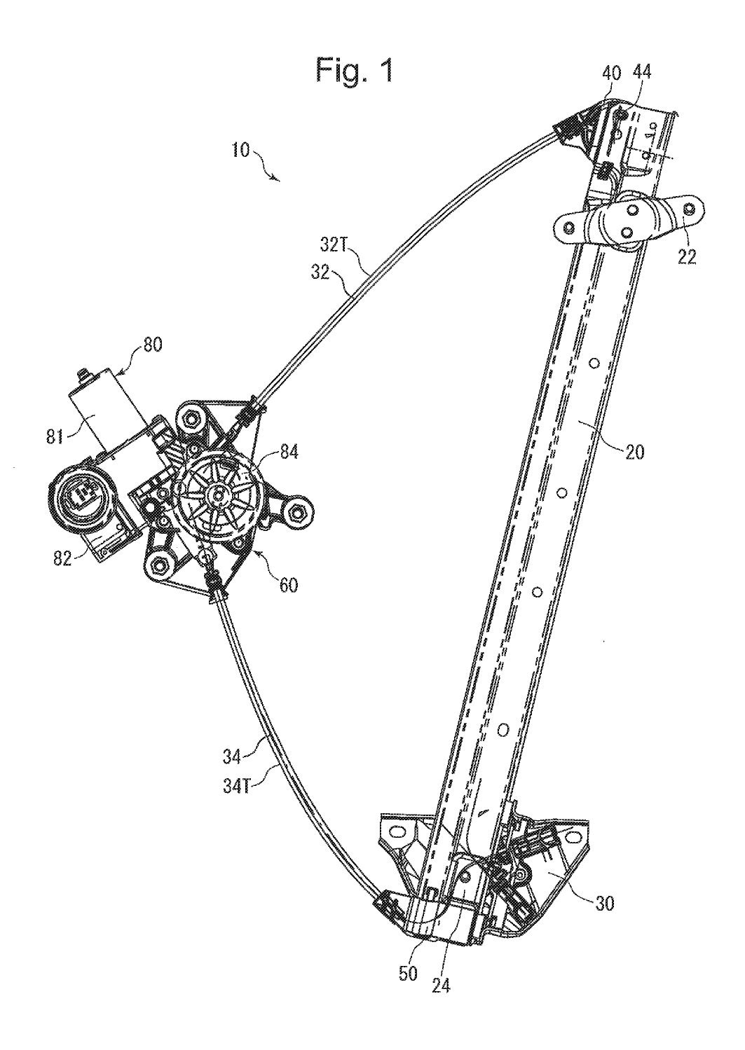

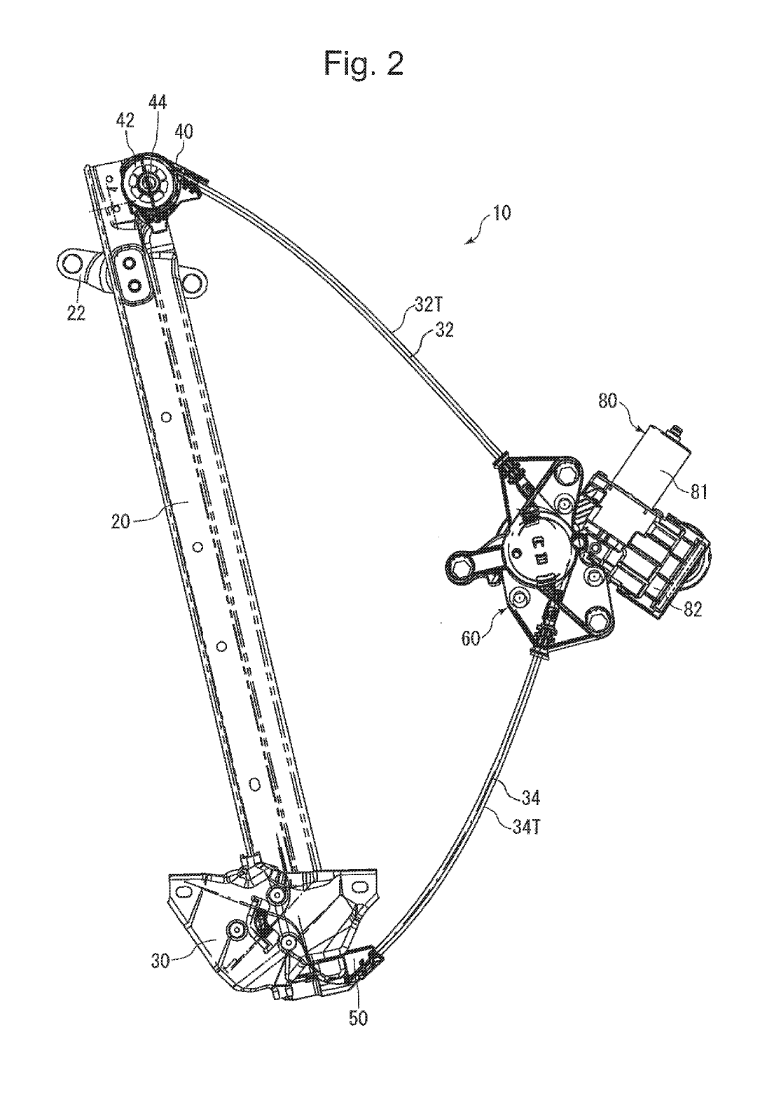

With reference to FIG. 1 to FIG. 9, a window regulator (a driving device for a vehicular opening-closing body) 10 according to the embodiment will be described.

The window regulator 10 includes a guide rail 20 as an elongated member. This guide rail 20 is mounted to an inside of a door panel (not illustrated) of a vehicle via brackets 22 and 24 disposed on different positions in a longitudinal direction. The guide rail 20 is arranged having the longitudinal direction in an almost height direction of the vehicle in a state of being mounted to the door panel of the vehicle.

The window regulator 10 includes a slider base (a glass carrier) 30 that is supported to the guide rail 20 so as to be freely movable up and down, and a window glass is supported to the slider base 30. Respective one ends of a pair of drive wires 32 and 34 are coupled to this slider base 30. The pair of drive wires 32 and 34 are made of conductive materials such as stainless steel, tungsten, titanium, and phosphor bronze.

A pulley bracket 40 is secured adjacent to an upper end in the longitudinal direction of the guide rail 20, and a guide pulley 42 is rotatably supported to this pulley bracket 40 via a pulley support shaft 44. The drive wire 32 extends from the slider base 30 in an upward direction of the guide rail 20 along the guide rail 20, and is supported by a wire guide groove formed on an outer peripheral surface of the guide pulley 42. Corresponding to advance and retreat of the drive wire 32, the guide pulley 42 rotates around the pulley support shaft 44.

A wire guide member 50 is disposed adjacent to a lower end in the longitudinal direction of the guide rail 20. The drive wire 34 extends from the slider base 30 in a downward direction of the guide rail 20 along the guide rail 20, and is guided by the wire guide member 50. The wire guide member 50 is secured to the guide rail 20, and the drive wire 34 is supported such that the drive wire 34 is configured to advance and retreat along a wire guide groove formed on the wire guide member 50.

The drive wire 32 coming out from the guide pulley 42 is inserted through a tubular outer tube 32T and wound around a drive drum 70 disposed inside a drum housing 60 to which the outer tube 32T is coupled. The drive wire 34 coming out from the wire guide member 50 is inserted through a tubular outer tube 34T and wound around the drive drum 70 disposed inside the drum housing 60 to which the outer tube 34T is coupled.

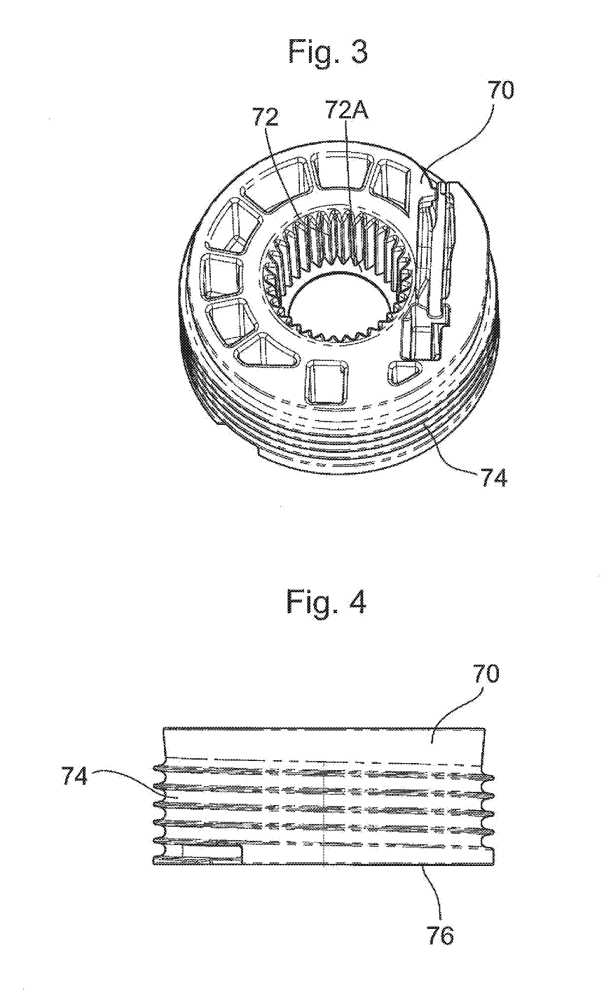

As illustrated in FIG. 3 and FIG. 4, the drive drum 70 has a columnar shape, and includes a shaft fitting hole 72 passing through in an axial direction in the center portion. This shaft fitting hole 72 has an inner surface on which sawtooth-shaped serrations are formed. The drive drum 70 has an outer peripheral surface (a peripheral surface) on which a spiral groove (a drive-wire winding groove) 74 is formed, and the drive wire 32 and the drive wire 34 are wound around the spiral groove 74. This spiral groove 74 varies the position in the axial direction of the drive drum 70 while circling along the outer peripheral surface of the drive drum 70. A portion excluding the shaft fitting hole 72 on a surface of the drive drum 70 facing the drum housing 60 side constitutes a circular planar sliding portion (a sliding portion) 76.

A motor unit 80 is mounted to the drum housing 60. The motor unit 80 includes a motor 81, a gear box 82 having a built-in reduction gear train that transmits rotation of an output shaft of this motor 81 while decreasing the rotation, and a fitting shaft (a rotation shaft, an output shaft) 83 (FIG. 8) to which a rotary driving force of the motor 81 is transmitted via the reduction gear train of this gear box 82. The motor unit 80 includes a cover 84 that covers an opening portion (a housing opening 61C of a drum housing portion 61 described later) of the drum housing 60, and the fitting shaft 83 projects from the cover 84 and fits to the shaft fitting hole 72 of the drive drum 70. The fitting shaft 83 has serrations fitting to the serrations of the shaft fitting hole 72, and driving the motor 81 in this fitting state rotates the drive drum 70 together with the fitting shaft 83 (FIG. 8).

The outer tube 32T has one end coupled to the pulley bracket 40 and the other end coupled to the drum housing 60, and the drive wire 32 is configured to advance and retreat in the outer tube 32T having thus determined both end positions. The outer tube 34T has one end coupled to the wire guide member 50 and the other end coupled to the drum housing 60, and the drive wire 34 is configured to advance and retreat in the outer tube 34T having thus determined both end positions.

The drum housing 60 is secured to the door panel (not illustrated) of the vehicle. When the driving force of the motor 81 positively/reversely rotates the drive drum 70, one of the drive wire 32 and the drive wire 34 increases a winding amount around the spiral groove 74 of the drive drum 70, and the other is drawn out from the spiral groove 74 of the drive drum 70, thus causing the slider base 30 to move along the guide rail 20 due to a relationship of pulling and loosening between the drive wire 32 and the drive wire 34. Corresponding to the move of the slider base 30, the window glass moves up and down.

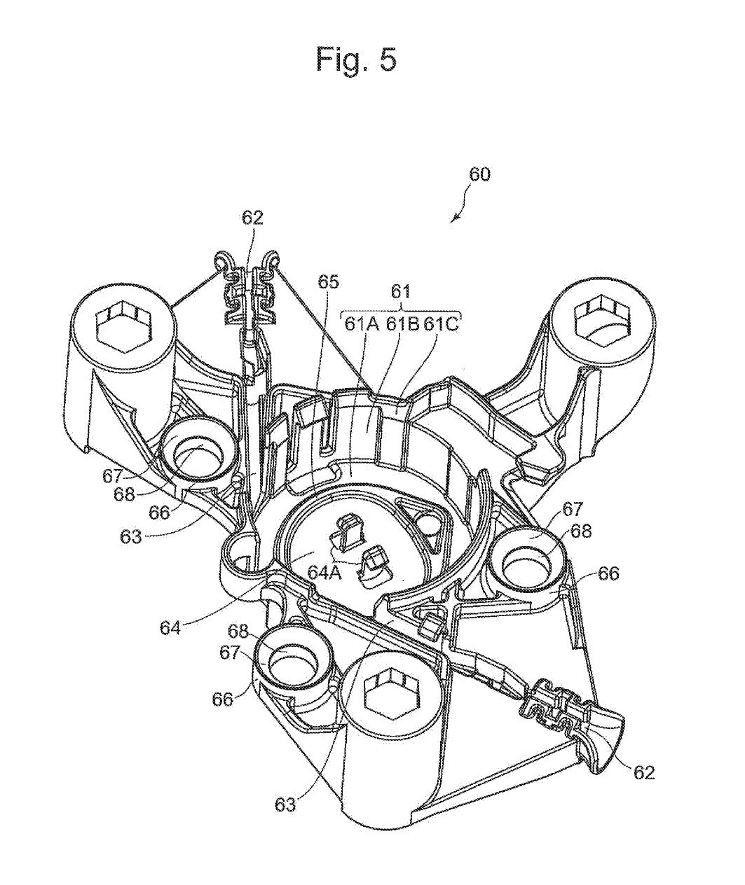

As illustrated in FIG. 5, the drum housing 60 includes the drum housing portion 61 and a pair of outer tube insertion portions 62. The drum housing portion 61 has a space surrounded by a bottom portion 61A and a cylindrically-shaped rising wall 61B formed on a peripheral edge of the bottom portion 61A, and has a side opening as a housing opening 61C on an opposite side of the bottom portion 61A. The drum housing 60 includes a pair of wire passage grooves 63, which are communicated with the drum housing portion 61, in mutually different directions (directions of the pulley bracket 40 and the wire guide member 50 in a completed state of the window regulator 10), and the pair of outer tube insertion portions 62 are formed on distal ends of the pair of wire passage grooves 63.

The bottom portion 61A of the drum housing 60 includes a drum support base 64 formed in an approximately circular shape in plan view. The drive drum 70 is inserted into the drum housing portion 61 in a state where the planar sliding portion (the sliding portion) 76 is placed on the drum support base 64. The drum support base 64 includes a shaft protrusion 64A in a bifurcated shape in the center, and the drive drum 70 includes a smooth cylindrical surface 72A on a part of the shaft fitting hole 72 (FIG. 3). Inserting the shaft protrusion 64A into the cylindrical surface 72A to bring both into sliding contact rotatably houses and supports the drive drum 70 to the drum housing 60. Transmission of the driving force of the motor 81 causes the drive drum 70 to rotate around its own rotation axis.

The bottom portion 61A of the drum housing 60 includes a slide bead (a sliding portion, a protrusion) 65 in an approximately circular shape in plan view so as to surround the shaft protrusion 64A of the drum support base 64. This slide bead 65 projects toward the planar sliding portion (the sliding portion) 76 of the drive drum 70 in a state where the drive drum 70 is housed and supported to the drum housing 60. Rotating the drive drum 70 with respect to the drum housing 60 causes the planar sliding portion (the sliding portion) 76 and the slide bead (the sliding portion, the protrusion) 65 as the sliding portions of the drive drum 70 and the drum housing 60 to slide (slidingly contact). A grease (a lubricant) is applied over this sliding portion (a slidingly-contact portion) to ensure smooth performances of the drive drum 70 and the drum housing 60.

With reference to mainly FIG. 5 to FIG. 8, a supporting structure of the drum housing 60 and the motor unit 80 will be described in detail.

The motor unit 80 includes three boss portions 85 projecting toward the drum housing 60. The boss portions 85 each have an inner surface on which a small-diameter screw hole (a screw hole) 85A, a medium-diameter through hole 85B, and a large-diameter through hole 85C are formed in an order from a distal end side (a drum housing 60 side). On each distal end side (the drum housing 60 side) of the boss portions 85, a tapered surface (a diameter-reducing tapered surface) 86 having a diameter reduced toward the distal end side (the drum housing 60 side) is formed. This tapered surface 86 has a most distal end portion (a most drum housing 60 side) on which a metallic distal end abutting portion 87 is formed. The metallic distal end abutting portion 87 may be integrally molded with the boss portion 85 of the motor unit 80, or the metallic distal end abutting portion 87 manufactured as a different member may be coupled to the boss portion 85 of the motor unit 80.

The drum housing 60 includes three boss receiving portions 66 that receive the three boss portions 85 of the motor unit 80. The boss receiving portions 66 each have an inner surface on which a reverse tapered surface (a diameter-expanding reverse tapered surface) 67 and an insertion hole 68 are formed in an order from a distal end side (a motor unit 80 side). The reverse tapered surface 67 has a diameter expanded toward the boss portion 85 (corresponding boss portion 85). The insertion hole 68 is continuous with a minimum diameter portion of this reverse tapered surface 67, and has an approximately constant diameter.

The tapered surface 86 of the motor unit 80 is configured to have a size and a shape so as to be gotten into the reverse tapered surface 67 of the drum housing 60. The distal end abutting portion 87 of the motor unit 80 is configured to have a diameter approximately identical to the diameters of the minimum diameter portion of the reverse tapered surface 67 and the insertion hole 68 of the drum housing 60.

The reverse tapered surface 67 of the drum housing 60 and the tapered surface 86 of the motor unit 80 mutually face, and have different taper angles. In this embodiment, the reverse tapered surface 67 of the drum housing 60 has the taper angle larger than (steeper than) the taper angle of the tapered surface 86 of the motor unit 80. In this embodiment, a surface connecting a maximum diameter portion of the tapered surface 86 to the most distal end portion of the distal end abutting portion 87 of the motor unit 80 has a taper angle approximately identical to the taper angle of the reverse tapered surface 67 of the drum housing 60.

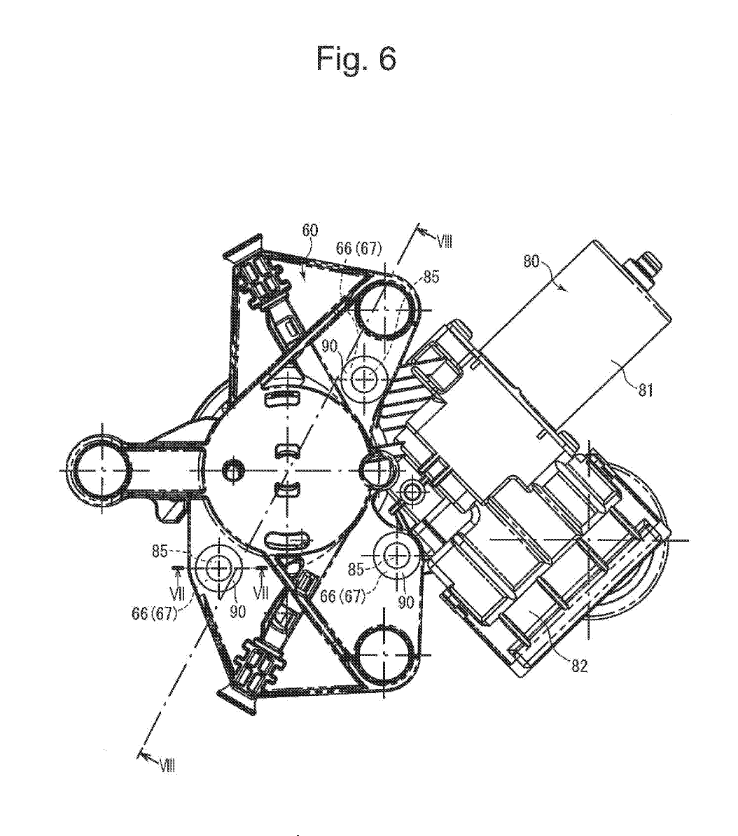

As apparent in FIG. 5 and FIG. 6, in plan view, the three boss portions 85 of the motor unit 80 and the three boss receiving portions 66 (the reverse tapered surfaces 67) of the drum housing 60 are disposed so as to surround the fitting shaft (the rotation shaft, the output shaft) 83 of the motor unit 80.

The motor unit 80 is joined (secured) to the drum housing 60 at the respective three boss portions 85 and boss receiving portions 66 with respective three metallic screw members (the securing member, for example, tapping screws) 90. The screw members 90 each have an engagement head portion 91 engaged with a peripheral edge portion of a surface on an opposite side of the reverse tapered surface 67 of the insertion hole 68 of the drum housing 60, a large-diameter insertion portion 92 inserted through the insertion hole 68 of the drum housing 60, a small-diameter screw portion 93 screwed into the small-diameter screw hole 85A formed on the boss portion 85 of the motor unit 80, and a step abutting portion 94 formed between the large-diameter insertion portion 92 and the small-diameter screw portion 93.

When joining (securing) the motor unit 80 to the drum housing 60 configured as described above, the three boss portions 85 of the motor unit 80 and the three boss receiving portions 66 of the drum housing 60 are roughly positioned, and both are brought closer together. Then, the tapered surfaces 86 and the distal end abutting portions 87 of the respective boss portions 85 are led (guided) to the reverse tapered surfaces 67 of the respective boss receiving portions 66. Accordingly, the motor unit 80 and the drum housing 60 can be stably assembled without requiring a high positioning accuracy. The above-described configuration eliminates a need for forming the three boss portions 85 and the three boss receiving portions 66 with high accuracies, thus ensuring simplification and cost reduction of manufacturing.

In a temporarily assembled state before joining (securing) the motor unit 80 to the drum housing 60 with the screw member 90, the tapered surfaces 86 and the distal end abutting portions 87 of the respective boss portions 85 of the motor unit 80 can contact the reverse tapered surfaces 67 of the respective boss receiving portions 66 of the drum housing 60.

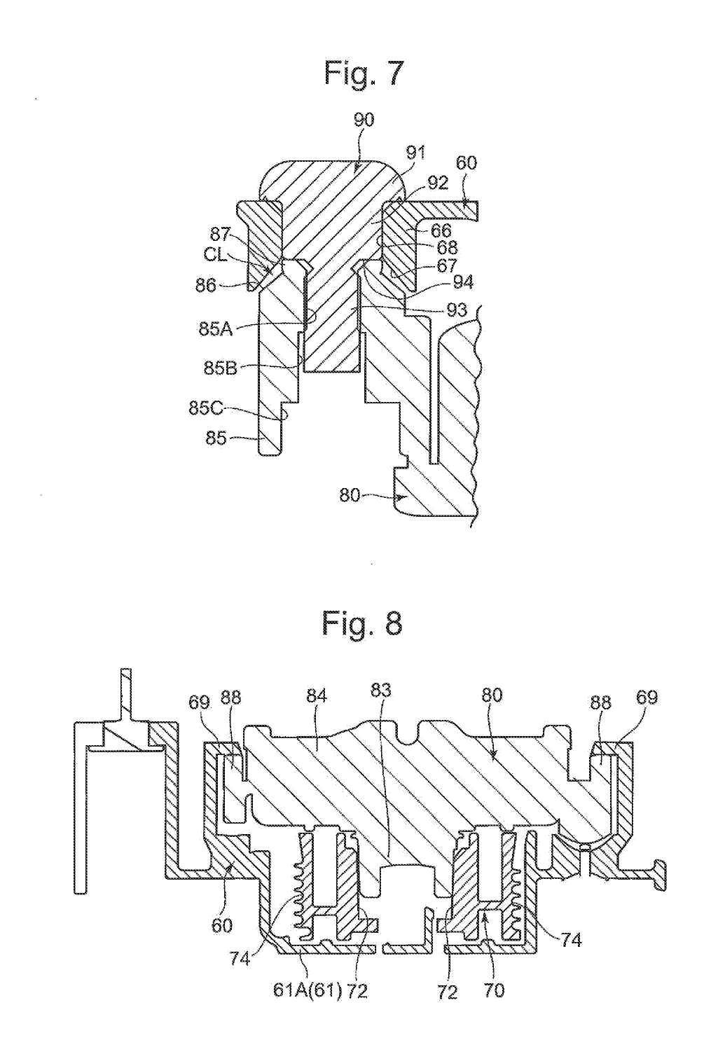

In contrast, in an assembled state after joining (securing) the motor unit 80 to the drum housing 60 with the screw member 90, as illustrated in FIG. 7, the tapered surfaces 86 and the distal end abutting portions 87 of the respective boss portions 85 of the motor unit 80 are not in contact with the reverse tapered surfaces 67 of the respective boss receiving portions 66 of the drum housing 60, and a clearance CL is disposed between both sides. On the other hand, the distal end abutting portions 87 of the respective boss portions 85 of the motor unit 80 abut on the respective step abutting portions 94 of the screw members 90 (a metal touch between metallic components). Then, at least one of the distal end abutting portion 87 of each of the boss portion 85 of the motor unit 80 and each of the step abutting portion 94 of the screw member 90 is squashed (flatly crushed). In view of this, even if the drum housing 60 is made of resin, the drum housing 60 is prevented from being damaged due to a harmful compressive force caused by screwing the screw member 90. The motor unit 80 also can be prevented from being damaged together with the drum housing 60, and causes of man-hour loss and failure in fastening can be removed.

The motor unit 80 and the drum housing 60 have “positioning abutting portions” in a direction where both face one another on positions other than between the respective boss portions 85 and the reverse tapered surfaces 67 of the respective boss receiving portions 66 (positioning abutting portions of the motor unit 80 and the drum housing 60 via the screw member 90). The number, the positions, the shapes and the like of the “positioning abutting portions” have freedom of choice, and the design can be variously changed. For example, an aspect in which “the positioning abutting portion” is disposed on a part where a joined body of the motor unit 80 and the drum housing 60 is fixed (fastened together) to a door panel (not illustrated) of a vehicle is employable. An aspect in which “the positioning abutting portions” are disposed on facing surfaces of the drum housing portion 61 of the drum housing 60 and the motor unit 80 is employable.

As illustrated in FIG. 8, the motor unit 80 has a locking claw hook portion 88, and the drum housing 60 has a locking claw 69 locked to the locking claw hook portion 88. Locking the locking claw 69 to the locking claw hook portion 88 prevents the motor unit 80 and the drum housing 60 from being unlocked or moving in the temporarily assembled state before joining (securing) the motor unit 80 to the drum housing 60 with the screw member 90, thus ensuring preventing the man-hour loss in assembling. Then, since the locking claw 69 and the locking claw hook portion 88 abut in a direction in which the respective boss portions 85 of the motor unit 80 and the respective boss receiving portions 66 of the drum housing 60 face one another, the above-described “positioning abutting portion” can be configured.

As illustrated in FIG. 8, the fitting shaft (the rotation shaft) 83 of the motor unit 80 fits to the shaft fitting hole 72 of the drive drum 70, and projects toward the bottom portion 61A of the drum housing portion 61 of the drum housing 60. In this embodiment, the fitting shaft 83 of the motor unit 80 projects to the drum housing 60 side with respect to each of the boss portions 85 of the motor unit 80 (an amount of projection of the fitting shaft 83 to the drum housing 60 side is greater than an amount of projection of the boss portion 85 to the drum housing 60 side).

Here, in assembling the motor unit 80 with the drum housing 60, preferably, a serration of the fitting shaft 83 of the motor unit 80 is in a specific (desired) rotation phase with a serration of the shaft fitting hole 72 of the drive drum 70. However, in actual assembling, it is highly likely that displacement of the rotation phase occurs between both serrations. In this embodiment, even if the displacement of the rotation phase has occurred between both serrations, the reverse tapered surface 67 of the boss receiving portion 66 of the drum housing 60 absorbs (accepts) the displacement of the rotation phase when receiving the boss portion 85 of the motor unit 80, thus ensuring the assembling. Then, after once the reverse tapered surface 67 of the boss receiving portion 66 of the drum housing 60 has received the boss portion 85 of the motor unit 80, simply rotatably driving the drive drum 70 by the motor unit 80 ensures the specific (desired) rotation phase between both serrations.

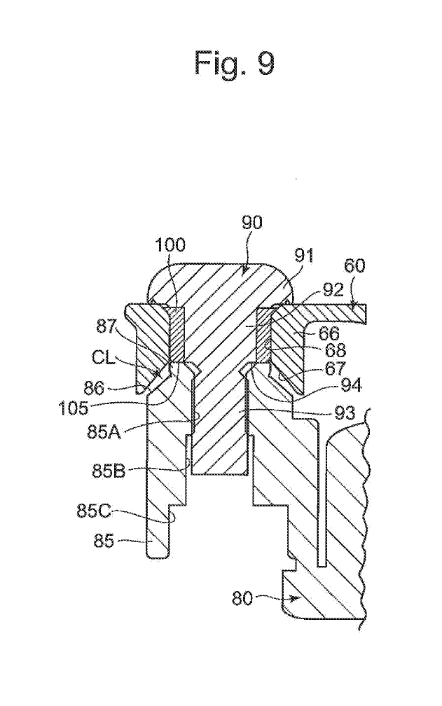

FIG. 9 illustrates another embodiment of “the positioning abutting portions” of the drum housing 60 and the motor unit 80. In this other embodiment, a metallic collar member 100 is integrally molded on an inner surface of the insertion hole 68 of the drum housing 60 (the metallic collar member 100 constitutes a part of the resin drum housing 60). In the assembled state after joining (securing) the motor unit 80 to the drum housing 60 with the screw member 90, the collar member 100 is positioned between the insertion hole 68 of the drum housing 60 and the large-diameter insertion portion 92 of the screw member 90. Then, the distal end abutting portion 87 of the boss portion 85 of the motor unit 80 abuts on a lower end abutting portion 105 of the collar member 100 (a metal touch between metallic components), thus positioning the drum housing 60 and the motor unit 80 in the facing direction. That is, the distal end abutting portion 87 of the boss portion 85 of the motor unit 80 and the lower end abutting portion 105 of the collar member 100 constitute “the positioning abutting portions.” On the other hand, in this other embodiment, the distal end abutting portion 87 of the boss portion 85 of the motor unit 80 does not abut on the step abutting portion 94 of the screw member 90 (94 is simply a step portion).

In FIG. 9, while the minimum diameter portion of the reverse tapered surface 67 of the drum housing 60, the step portion 94 of the screw member 90, and the lower end abutting portion 105 of the collar member 100 are approximately identical in height, these heights may be mutually different. For example, the lower end abutting portion 105 of the collar member 100 may be projected downward (the distal end abutting portion 87 of the boss portion 85 of the motor unit 80) with respect to the minimum diameter portion of the reverse tapered surface 67 of the drum housing 60 and the step portion 94 of the screw member 90.

Thus, according to the embodiment, the motor unit 80 includes a plurality of the boss portions 85 that project toward the drum housing 60, the drum housing 60 includes a plurality of the boss receiving portions 66 that receive the plurality of the boss portions 85, at least one of the plurality of the boss receiving portions 66 has the reverse tapered surface 67 that has the diameter expanded toward the corresponding boss portion 85, and the clearance CL is disposed between the boss portion 85 and the reverse tapered surface 67 in a state where the motor unit 80 and the drum housing 60 are supported. The motor unit 80 and the drum housing 60 have the positioning abutting portions (for example, the locking claw 69 of the drum housing 60 and the locking claw hook portion 88 of the motor unit 80, and/or the distal end abutting portion 87 of the boss portion 85 of the motor unit 80 and the lower end abutting portion 105 of the collar member 100 are included, while the positioning abutting portion is not limited to them) in the direction where the motor unit 80 and the drum housing 60 face one another (the direction where the plurality of the boss portions 85 and the plurality of the boss receiving portions 66 face one another) on the position other than between the boss portion 85 and the reverse tapered surface 67 (the positioning abutting portions of the motor unit 80 and the drum housing 60 via the screw member 90). Accordingly, the drum housing 60 and the motor unit 80 can be stably assembled without requiring the high positioning accuracy.

In the above-described embodiment, an exemplary case has been described where the driving device for the vehicular opening-closing body of the present invention is applied to the supporting structure of the drum housing 60 and the motor unit 80 of the window regulator 10. However, the driving device for the vehicular opening-closing body of the present invention is applicable to another supporting structure of a supporting member and a supported member for a vehicle.

In the above-described embodiment, an exemplary case has been described where the motor unit 80 and the drum housing 60 have the three boss portions 85 and the three boss receiving portions 66 (the reverse tapered surfaces 67), respectively. However, the number of sets of the boss portion and the boss receiving portion (the reverse tapered surface) is not limited to this, and the design can be variously changed. For example, the number of sets of the boss portion and the boss receiving portion (the reverse tapered surface) may be two, or four or more. Note that, for stably supporting the motor unit 80 and the drum housing 60, preferably, the number of sets of the boss portion and the boss receiving portion (the reverse tapered surface) is at least three or more.

In the above-described embodiment, an exemplary case has been described where every (three) boss receiving portion 66 of the drum housing 60 has the reverse tapered surface 67. However, an aspect where only a part (for example, one or two boss receiving portions 66 among the three boss receiving portions 66) of the boss receiving portions 66 of the drum housing 60 includes the reverse tapered surface 67 may be employed.

While, in the above-described embodiment, an exemplary case has been described where the boss portion 85 of the motor unit 80 has the tapered surface 86, an aspect where the tapered surface 86 is omitted and the boss portion 85 of the motor unit 80 has an approximately constant diameter may be employed.

In the above-described embodiment, an exemplary case has been described where, in the assembled state after joining (securing) the motor unit 80 to the drum housing 60 with the screw member 90, the tapered surfaces 86 and the distal end abutting portions 87 of the respective boss portions 85 of the motor unit 80 are not in contact with the reverse tapered surfaces 67 of the respective boss receiving portions 66 of the drum housing 60. However, an aspect where the tapered surfaces 86 and the distal end abutting portions 87 of the respective boss portions 85 of the motor unit 80 are partially in contact with the reverse tapered surfaces 67 of the respective boss receiving portions 66 of the drum housing 60, and the clearance CL is disposed between both sides may be employed.

In the above-described embodiment, an exemplary case has been described where the motor unit 80 includes the boss portion 85 and the drum housing 60 includes the boss receiving portion 66 (the reverse tapered surface 67). However, having the reversed positional relationship, an aspect where the drum housing includes the boss portion and the motor unit includes the boss receiving portion (the reverse tapered surface) may be employed.

### INDUSTRIAL APPLICABILITY

The driving device for the vehicular opening-closing body of the present invention is preferably applied to, for example, a window regulator configured to move a window glass of a vehicle up and down.

### DESCRIPTION OF REFERENCE SIGNS

10 window regulator (driving device for vehicular opening-closing body)
20 guide rail
22 bracket
24 bracket
30 slider base (glass carrier)
32 drive wire
32T outer tube
34 drive wire
34T outer tube
40 pulley bracket
42 guide pulley
44 pulley support shaft
50 wire guide member
60 drum housing
61 drum housing portion
61A bottom portion
61B rising wall
61C housing opening
62 outer tube insertion portion
63 wire passage groove
64 drum support base
64A shaft protrusion
65 slide bead (sliding portion, protrusion)
66 boss receiving portion
67 reverse tapered surface (diameter-expanding reverse tapered surface)
68 insertion hole
69 locking claw
70 drive drum
72 shaft fitting hole
72A cylindrical surface
74 spiral groove (drive-wire winding groove)
76 planar sliding portion (sliding portion)
80 motor unit
81 motor
82 gear box
83 fitting shaft (rotation shaft, output shaft)
84 cover
85 boss portion
85A small-diameter screw hole (screw hole)
85B medium-diameter through hole
85C large-diameter through hole
86 tapered surface (diameter-reducing tapered surface)
87 distal end abutting portion (positioning abutting portion)
88 locking claw hook portion
90 screw member (securing member, tapping screw)
91 engagement head portion
92 large-diameter insertion portion
93 small-diameter screw portion
94 step abutting portion (step portion)
100 metallic collar member (part of drum housing) (positioning abutting portion)
105 lower end abutting portion (positioning abutting portion)
CL clearance

1. A driving device for a vehicular opening-closing body, comprising:
a drum housing that houses a drive drum, the drive drum driving the vehicular opening-closing body; and
a motor unit that includes an output shaft, the output shaft integrally rotating with the drive drum, wherein:
one of the drum housing and the motor unit includes a plurality of boss portions projecting toward another one of the drum housing and the motor unit, and securing members for securing the drum housing and the motor unit are secured to the plurality of boss portions,
the other one of the drum housing and the motor unit includes a plurality of boss receiving portions that receive the plurality of boss portions,
at least one of the plurality of boss receiving portions has a reverse tapered surface that has a diameter expanded toward a corresponding boss portion, and
in a state where the drum housing and the motor unit are supported, a clearance is disposed between the boss portion and the reverse tapered surface.

2. The driving device for the vehicular opening-closing body according to claim 1, wherein
the plurality of boss portions and the plurality of boss receiving portions are disposed so as to surround the output shaft of the motor unit.

3. The driving device for the vehicular opening-closing body according to claim 1, wherein:
the plurality of boss portions are disposed on the motor unit,
the plurality of boss receiving portions are disposed on the drum housing, and
the output shaft of the motor unit projects to the drum housing side with respect to the plurality of boss portions of the motor unit.

4. The driving device for the vehicular opening-closing body according to claim 1, wherein
the securing member and a distal end portion of the boss portion are made of metallic material, and at least one of abutting portions of both sides is squashed.

5. The driving device for the vehicular opening-closing body according to claim 1, wherein
abutting portions are disposed on facing surfaces of a drum housing portion of the drum housing and the motor unit in a direction where the plurality of boss portions and the plurality of boss receiving portions face one another.
